(19) United States
(12) Patent Application Publication
(10) Pub. No.: US 2015/0315875 A1
(43) Pub. Date: Nov. 5, 2015

(54) Red Mud Solids in Spacer Fluids

(71) Applicant: Halliburton Energy Services, Inc., Houston, TX (US)

(72) Inventors: Jiten Chatterji, Duncan, OK (US); Thomas Jason Pisklak, Cypress, TX (US); Darrell Chad Brenneis, Marlow, OK (US); James Robert Benkley, Duncan, OK (US)

(73) Assignee: HALLIBURTON ENERGY SERVICES, INC., Houston, TX (US)

(21) Appl. No.: 14/363,370

(22) PCT Filed: Apr. 30, 2014
(86) PCT No.: PCT/US2014/036120

§ 371 Date: Jun. 6, 2014

(51) Int. Cl. E21B 37/00; E21B 33/14; B01F 15/02

(52) U.S. Cl. CPC E21B 37/00; B01F 15/0283; E21B 33/14; B01F 2215/0047

(57) ABSTRACT

Disclosed are spacer fluids and methods of use in subterranean formations. Embodiments may include using a spacer fluid comprising red mud solids and water to displace a drilling fluid in a wellbore.

### BACKGROUND

Embodiments relate to spacer fluids for use in subterranean operations and, more particularly, in certain embodiments, to spacer fluids that comprise red mud solids and methods of use in subterranean formations.

In cementing operations, such as well construction and remedial cementing, cement compositions are commonly utilized. Cement compositions may be used in primary cementing operations whereby pipe strings, such as casing and liners, are cemented in wellbores. In a typical primary cementing operation, a cement composition may be pumped into an annulus between the exterior surface of the pipe string disposed therein and the walls of the wellbore (or a larger conduit in the wellbore). The cement composition may set in the annular space, thereby forming an annular sheath of hardened, substantially impermeable material (i.e., a cement sheath) that may support and position the pipe string in the wellbore and may bond the exterior surface of the pipe string to the wellbore walls (or the larger conduit). Among other things, the cement sheath surrounding the pipe string should function to prevent the migration of fluids in the annulus, as well as protect the pipe string from corrosion. Cement compositions also may be used in remedial cementing methods, such as in squeeze cementing for sealing voids in a pipe string, cement sheath, gravel pack, subterranean formation, and the like. Cement compositions may also be used in surface applications, for example, construction cementing.

Preparation of the wellbore for cementing operations may be important in achieving optimal zonal isolation. Conventionally, wellbores may be cleaned and prepared for the cement composition with a fluid train that precedes the cement composition and can include spacer fluids, flushes, water-based muds, and the like. Spacer fluids may be used in wellbore preparation for drilling fluid displacement before introduction of the cement composition. The spacer fluids may enhance solids removal while also separating the drilling fluid from a physically incompatible fluid, such as a cement composition. Spacer fluids may also be placed between different drilling fluids during drilling change outs or between a drilling fluid and completion brine. Certain components of spacer fluids may be limited and/or restricted in some geographical locations.

### BRIEF DESCRIPTION OF THE DRAWINGS

These drawings illustrate certain aspects of some of the embodiments of the present invention, and should not be used to limit or define the invention.

FIG. 1 is a schematic illustration of an example system for the preparation and delivery of a spacer fluid comprising red mud solids to a wellbore.

FIG. 2 is a schematic illustration of example surface equipment that may be used in the placement of a spacer fluid comprising red mud solids into a wellbore.

FIG. 3 is a schematic illustration of an example in which a spacer fluid comprising red mud solids is used between a cement composition and a drilling fluid.

FIG. 4 is a schematic illustration of the embodiment of FIG. 3 showing displacement of the drilling fluid.

### DETAILED DESCRIPTION

Embodiments relate to spacer fluids for use in subterranean operations and, more particularly, in certain embodiments, to spacer fluids that comprise red mud solids and methods of use in subterranean formations. In accordance with present embodiments, the spacer fluids may improve the efficiency of wellbore cleaning and wellbore fluid removal. One of the many potential advantages to these methods and compositions is that an effective use for red mud solids may be provided thus minimizing the amount of the waste being deposited in disposal sites, such as containment reservoirs. Another potential advantage of these methods and compositions is that the cost of subterranean operations may be reduced by replacement of higher cost additives (e.g., surfactants, weighting agents, etc.) with the red mud solids. Yet another potential advantage of these methods and compositions is that the red mud solids may be used in place of other additives such as cement kiln dust whose supply may be limited in certain geographic locations.

The spacer fluids may generally comprise red mud solids and water. Embodiments of the spacer fluids comprising the red mud solids may be consolidating. For example, the spacer fluids may consolidate to develop gel strength or compressive strength when placed in the wellbore. Accordingly, the spacer fluid left in the wellbore may function to provide a substantially impermeable barrier to seal off formation fluids and gases and consequently serve to mitigate potential fluid migration. The spacer fluid in the wellbore annulus may also protect the pipe string or other conduit from corrosion. The spacer fluid may also serve to protect the erosion of the cement sheath formed by subsequently introduced cement compositions.

The spacer fluids generally should have a density suitable for a particular application as desired by those of ordinary skill in the art, with the benefit of this disclosure. In some embodiments, the spacer fluids may have a density in the range of from about 4 pounds per gallon (“ppg”) to about 24 ppg. In other embodiments, the spacer fluids may have a density in the range of about 4 ppg to about 17 ppg. In yet other embodiments, the spacer fluids may have a density in the range of about 8 ppg to about 13 ppg. Embodiments of the spacer fluids may be foamed or unfoamed or comprise other means to reduce their densities known in the art, such as lightweight additives. Those of ordinary skill in the art, with the benefit of this disclosure, should recognize the appropriate density for a particular application.

As used herein, the term “red mud solids” refers to a solid waste/by-product produced when bauxite is refined using the Bayer process to produce alumina. The Bayer process is the most common method for extracting alumina from bauxite ore. In the Bayer process, the bauxite is processed resulting in an insoluble residue, which is the bauxite ore from which the alumina has been extracted. This insoluble residue is commonly produced in the Bayer process in a sludge or mud commonly known as “red mud.” Red mud may also be known as “bauxite refinery residue.” A typical alumina plant may produce one to two times as much red mud as alumina. The red mud together with the incorporated red mud solids have typically been considered an undesirable by product that can add costs to the production of alumina as well as environmental concerns associated with its disposal. Currently, the red mud is typically held in disposal sites such as landfills or retention ponds, or left exposed in piles on the surface. The term “red mud solids,” as used herein, is also intended to encompass red mud solids that have been processed or stabilized in some manner, such as by drying, for example.

The red mud solids may be provided in any suitable form, including as dry solids or in red mud, which may comprise red mud solids and water. The water content of the red mud may be as high as 25% by weight of the red mud or potentially even higher. In some embodiments, the red mud comprising the red mud solids may be dried to reduce its water content prior to use. Natural or mechanical means may be used for drying the red mud. By way example, the red mud may be air dried or drum dried.

While the chemical analysis of red mud solids will typically vary from various manufacturers depending on a number of factors, including the particular solid material feed, process conditions, treatments, and the like, red mud typically may comprise a mixture of solid and metallic oxide-bearing minerals. By way of example, the red mud solids may comprise a number of different oxides (based on oxide analysis), including, without limitation, Na₂O, MgO, Al₂O₃, SiO₂, CaO, and/or Fe₂O₃. Moreover, the red mud solids generally may comprise a number of different crystal structures, including, without limitation, calcite (CaCO₃), quartz (SiO₂), hematite (Fe₂O₃), hauyne (Na₃CaAl₃Si₃O₁₂(SO₄)₂), kaolinite, and/or muscovite.

The red mud solids may, in some embodiments, serve as a low cost component in spacer fluids. In addition, the red mud solids may have pozzolanic activity such that the spacer fluids comprising the red mud solids may consolidate to develop compressive strength. In some embodiments, lime may be included in the spacer fluid for activation of the red mud solids for consolidation of the spacer fluid. In further embodiments, a cement set activator (e.g., calcium chloride) may be included in the spacer fluid in combination with or in addition to the lime for activation of the red mud solids. Additional pozzolanic materials such as pumice may also be included in the spacer fluids.

Further, the red mud solids may be included in the spacer fluids in a crushed, ground, powder, or other suitable particulate form. In some embodiments, the red mud solids may have a d50 particle size distribution of from about 1 micron to about 200 microns and, alternatively, from about 10 microns to about 50 microns. By way of example, the red mud solids may have a d50 particle size distribution ranging between any of and/or including any of about 1 micron, about 5 microns, about 10 microns, about 20 microns, about 30 microns, about 40 microns, about 50 microns, about 60 microns, about 70 microns, about 80 microns, about 90 microns, about 100 microns, about 150 microns, or about 200 microns. One of ordinary skill in the art, with the benefit of this disclosure, should be able to select an appropriate particle size for the red mud solids for a particular application.

The red mud solids may be included in the spacer fluids in an amount suitable for a particular application. For example, the red mud solids may be included in the spacer fluids in an amount in the range of from about 0.1% to about 80% by weight of the spacer fluid. By way of further example, the red mud solids may be present in an amount ranging between any of and/or including any of about 0.1%, about 1%, about 10%, about 20%, about 30%, about 40%, about 50%, about 60%, about 70%, or about 80% by weight of the spacer fluid. In some embodiments, the red mud solids may be present in an amount of about 50% to about 70% by weight of the spacer fluid. One of ordinary skill in the art, with the benefit of this disclosure, should recognize the appropriate amount of the red mud solids to include for a chosen application.

The water used in the spacer fluids may include, for example, freshwater, saltwater (e.g., water containing one or more salts dissolved therein), brine (e.g., saturated saltwater produced from subterranean formations), seawater, or any combination thereof. Generally, the water may be from any source, provided that the water does not contain an excess of compounds that may undesirably affect other components in the spacer fluid. The water may be provided with the red mud solids, for example, in the red mud, or may be separately added to the red mud solids. In some embodiment, additional water may be combined with red mud to form a spacer fluid. The water may be included in an amount sufficient to form a pumpable slurry. For example, the water may be included in the spacer fluids in an amount in the range of from about 40% to about 200% by weight of red mud solids and, alternatively, in an amount in a range of from about 40% to about 150% by weight of red mud solids. By way of further example, the water may be present in an amount ranging between any of and/or including any of about 40%, about 50%, about 60%, about 70%, about 80%, about 90%, about 100%, about 110%, about 120%, about 130%, about 140%, about 150%, about 160%, about 170%, about 180%, about 190%, or about 200% by weight of red mud solids. One of ordinary skill in the art, with the benefit of this disclosure, should recognize the appropriate amount of the water to include for a chosen application.

The spacer fluids may optionally comprise lime. As previously mentioned, the lime may be included in a spacer fluid for activation of the red mud solids. Further, the lime in some embodiments may comprise hydrated lime. As used herein, the term “hydrated lime” will be understood to mean calcium hydroxide. In some embodiments, the lime may be provided as quicklime (calcium oxide) which hydrates when mixed with water to form a hydrated lime. Where present, the lime may be included in the spacer fluids in an amount in the range of from about 1% to about 100% by weight of red mud solids, for example. In some embodiments, the lime may be present in an amount ranging between any of and/or including any of about 1%, about 5%, about 10%, 20%, about 40%, about 60%, about 80%, or about 100% by weight of red mud solids. One of ordinary skill in the art, with the benefit of this disclosure, should recognize the appropriate amount of lime to include for a chosen application.

The spacer fluids may optionally comprise kiln dust. “Kiln dust,” as that term is used herein, refers to a solid material generated as a by-product of the heating of certain materials in kilns. The term “kiln dust” as used herein is intended to include kiln dust made as described herein and equivalent forms of kiln dust. Kiln dust such as certain cement kiln dusts may exhibits cementitious properties in that it can set and harden in the presence of water. Examples of suitable kiln dusts include cement kiln dust, lime kiln dust, and combinations thereof. Cement kiln dust may be generated as a by-product of cement production that is removed from the gas stream and collected, for example, in a dust collector. Usually, large quantities of cement kiln dust are collected in the production of cement that are commonly disposed of as waste. Disposal of the cement kiln dust can add undesirable costs to the manufacture of the cement, as well as the environmental concerns associated with its disposal. The chemical analysis of the cement kiln dust from various cement manufactures varies depending on a number of factors, including the particular kiln feed, the efficiencies of the cement production operation, and the associated dust collection systems. Cement kin dust generally may comprise a variety of oxides, such as SiO₂, Al₂O₃, Fe₂O₃, CaO, MgO, SO₃, Na₂O, and K₂O. Problems may also be associated with the disposal of lime kiln dust, which may be generated as a by-product of the calcination of lime. The chemical analysis of lime kiln dust from various lime manufacturers varies depending on a number of factors, including the particular limestone or dolomitic limestone feed, the type of kiln, the mode of operation of the kiln, the efficiencies of the lime production operation, and the associated dust collection systems. Lime kiln dust generally may comprise varying amounts of free lime and free magnesium, lime stone, and/or dolomitic limestone and a variety of oxides, such as SiO₂, Al₂O₃, Fe₂O₃, CaO, MgO, SO₃, Na₂O, and K₂O, and other components, such as chlorides.

The kiln dust may be included in the spacer fluids in an amount suitable for a particular application. Where present, the kiln dust may be included in an amount in a range of from about 1% to about 200% by weight of red mud solids. By way of example, the kiln dust may be present in an amount ranging between any of and/or including any of about 1%, about 20%, about 40%, about 60%, about 80%, about 100%, about 120%, about 140%, about 160%, about 180%, or about 200% by weight of red mud solids. In one particular embodiment, the kiln dust may be present in an amount in a range of from about 25% to about 75% by weight of red mud solids and, alternatively, from about 40% to 60% by weight of red mud solids. One of ordinary skill in the art, with the benefit of this disclosure, should recognize the appropriate amount of kiln dust to include for a chosen application.

The spacer fluids may optionally comprise pumice. Generally, pumice is a volcanic rock that may exhibit pozzolanic properties. Embodiments of the pumice may have a d50 particle size in a range of from about from about 1 micron to about 200 microns. An example of a suitable pumice is available from Hess Pumice Products, Inc., Malad, Id., as DS-325 lightweight aggregate, having a particle size of less than about 15 microns. Where used, the pumice generally may be included in the spacer fluids in an amount desired for a particular application. In some embodiments, pumice may be included in the spacer fluids in an amount in the range of from about 1% to about 100% by weight of red mud solids. In some embodiments, the pumice may be present in an amount ranging between any of and/or including any of about 1%, about 5%, about 10%, 20%, about 40%, about 60%, about 80%, or about 100% by weight of red mud solids. One of ordinary skill in the art, with the benefit of this disclosure, should recognize the appropriate amount of the pumice to include for a chosen application.

The spacer fluids may optionally comprise barite. In some embodiments, the barite may be sized barite. Sized barite generally refers to barite that has been separated, sieved, ground, or otherwise sized to produce barite having a desired particle size. For example, the barite may be sized to produce barite having a particle size of about 200 microns or less. Where used, the barite generally may be included in the spacer fluids in an amount desired for a particular application. In some embodiments, the barite may be present in an amount in a range of from about 1% to about 100% by weight of red mud solids. For example, the barite may be present in an amount ranging between any of and/or including any of about 1%, about 5%, about 10%, 20%, about 40%, about 60%, about 80%, or about 100% by weight of red mud solids. One of ordinary skill in the art, with the benefit of this disclosure, should recognize the appropriate amount of the barite to include for a chosen application.

The spacer fluids may optionally include a cement set activator to activate the pozzolanic reaction of the red mud solids. Examples of suitable cement set activators include, but are not limited to: amines such as triethanolamine, diethanolamine; silicates such as sodium silicate; zinc formate; calcium acetate; Groups IA and HA hydroxides such as sodium hydroxide, magnesium hydroxide, and calcium hydroxide; monovalent salts such as sodium chloride; divalent salts such as calcium chloride; and combinations thereof. The cement set activator may be added to embodiments of the spacer fluids in an amount sufficient to induce the spacer fluid set into a hardened mass. In certain embodiments, the cement set activator may be added to the spacer fluid in an amount in the range of about 0.1% to about 20% by weight of red mud solids. In specific embodiments, the cement set activator may be present in an amount ranging between any of and/or including any of about 0.1%, about 1%, about 5%, about 10%, about 15%, or about 20% by weight of red mud solids. One of ordinary skill in the art, with the benefit of this disclosure, should recognize the appropriate amount of the cement set activator to include for a chosen application.

A wide variety of additional additives may be included in the spacer fluids as deemed appropriate by one skilled in the art, with the benefit of this disclosure. Examples of such additives include, but are not limited to: supplementary cementitious materials, weighting agents, viscosifying agents (e.g., clays, hydratable polymers, guar gum), fluid loss control additives, lost circulation materials, filtration control additives, dispersants, foaming additives, defoamers, corrosion inhibitors, scale inhibitors, formation conditioning agents, and a water-wetting surfactants. Water-wetting surfactants may be used to aid in removal of oil from surfaces in the wellbore (e.g., the casing) to enhance cement and consolidating spacer fluid bonding. Examples of suitable weighting agents include, for example, materials having a specific gravity of 3 or greater, such as barite. Specific examples of these, and other, additives include: organic polymers, biopolymers, latex, ground rubber, surfactants, crystalline silica, amorphous silica, silica flour, fumed silica, nano-clays (e.g., clays having at least one dimension less than 100 nm), salts, fibers, hydratable clays, microspheres, rice husk ash, micro-fine cement (e.g., cement having an average particle size of from about 5 microns to about 10 microns), metakaolin, zeolite, shale, Portland cement, Portland cement interground with pumice, perlite, barite, slag, lime (e.g., hydrated lime), gypsum, and any combinations thereof, and the like. A person having ordinary skill in the art, with the benefit of this disclosure, should readily be able to determine the type and amount of additive useful for a particular application and desired result.

As previously mentioned, the spacer fluids may consolidate after placement in the wellbore. By way of example, the spacer fluids may develop gel and/or compressive strength when left in the wellbore. As a specific example of consolidation, when left in a wellbore annulus (e.g., between a subterranean formation and the pipe string disposed in the subterranean formation or between the pipe string and a larger conduit disposed in the subterranean formation), the spacer fluid may consolidate to develop static gel strength and/or compressive strength. The consolidated mass formed in the wellbore annulus may act to support and position the pipe string in the wellbore and bond the exterior surface of the pipe string to the walls of the wellbore or to the larger conduit. The consolidated mass formed in the wellbore annulus may also provide a substantially impermeable barrier to seal off formation fluids and gases and consequently also serve to mitigate potential fluid migration. The consolidated mass formed in the wellbore annulus may also protect the pipe string or other conduit from corrosion.

In some embodiments, the spacer fluids may consolidate to develop compressive strength. By way of example, the spacer fluids comprising red mud solids, water, and optional additives may develop a 24-hour compressive strength of about 50 psi, about 100 psi, or greater. In some embodiments, the compressive strength values may be determined at a temperature ranging from 100° F. to 200° F. Compressive strength is generally the capacity of a material or structure to withstand axially directed pushing forces. Typical sample geometry and sizes for measurement are similar to, but not limited to, those used for characterizing oil well cements: 2 inch cubes; or 2 inch diameter cylinders that are 4 inches in length; or 1 inch diameter cylinders that are 2 inches in length; and other methods known to those skilled in the art of measuring “mechanical properties” of oil well cements. For example, the compressive strength may be deter mined by crushing the samples in a compression-testing machine. The compressive strength is calculated from the failure load divided by the cross-sectional area resisting the load and is reported in units of pound-force per square inch (psi). Compressive strengths may be determined in accordance with API RP 10B-2, Recommended Practice for Testing Well Cements, First Edition, July 2005.

Embodiments of the spacer fluids of the present invention may be prepared in accordance with any suitable technique. In some embodiments, the desired quantity of water may be introduced into a mixer (e.g., a cement blender) followed by the dry blend. The dry blend may comprise the red mud solids and additional solid additives (e.g., pumice, kiln dust, barite, and the like), for example. Additional liquid additives, if any, may be added to the water as desired prior to, or after, combination with the dry blend. This mixture may be agitated for a sufficient period of time to form a pumpable slurry. By way of example, pumps may be used for delivery of this pumpable slurry into the wellbore. As will be appreciated by those of ordinary skill in the art, with the benefit of this disclosure, other suitable techniques for preparing the spacer fluids may be used in accordance with embodiments of the present invention.

An example method may include a method of displacing a first fluid from a wellbore, the wellbore penetrating a subterranean formation. The method may comprise providing a spacer fluid that comprises red mud solids and water. One or more optional additives may also be included in the spacer fluid as discussed herein. The method may further comprise introducing the spacer fluid into the wellbore to displace at least a portion of the first fluid from the wellbore. In some embodiments, the spacer fluid may displace the first fluid from a wellbore annulus, such as the annulus between a pipe string and the subterranean formation or between the pipe string and a larger conduit. In some embodiments, the first fluid displaced by the spacer fluid comprises a drilling fluid. By way of example, the spacer fluid may be used to displace the drilling fluid from the wellbore. In addition to displacement of the drilling fluid from the wellbore, the spacer fluid may also remove the drilling fluid from the walls of the wellbore. Additional steps in embodiments of the method may comprise introducing a pipe string into the wellbore, introducing a cement composition into the wellbore with the spacer fluid separating the cement composition and the first fluid. In an embodiment, the cement composition may be allowed to set in the wellbore. The cement composition may include, for example, cement and water.

Another example method may comprise using a spacer fluid comprising red mud solids and water to displace a drilling fluid in a wellbore. One or more optional additives may also be included in the spacer fluid as discussed herein. The method may further comprise introducing a cement composition into the wellbore after the spacer fluid, wherein the spacer fluid separates the cement composition from the drilling fluid. Any of the previous embodiments of a spacer fluid described previously may apply in the context of this example method.

Another example method may comprise using a spacer fluid comprising red mud solids, hydrated lime, and water to displace an aqueous drilling fluid in a wellbore annulus. The method may further comprise introducing a cement composition into the wellbore annulus after the spacer fluid. At least a portion of the spacer fluid may consolidate in the wellbore annulus to form a hardened mass. One or more optional additives may also be included in the spacer fluid as discussed herein. Any of the previous embodiments of a spacer fluid described previously may apply in the context of this example method.

An embodiment may provide a system comprising: a cement composition for use in cementing in a wellbore; a spacer fluid for separating the cement composition from a drilling fluid in the wellbore, wherein the spacer fluid comprising red mud solids and water; mixing equipment for mixing the spacer fluid; and pumping equipment for delivering the spacer fluid into a wellbore. One or more optional additives may also be included in the spacer fluid as discussed herein. Any of the previous embodiments of a spacer fluid described previously may apply in the context of this example system.

As described herein, the spacer fluid may prevent the cement composition from contacting the first fluid, such as a drilling fluid. The spacer fluid may also remove the drilling fluid, dehydrated/gelled drilling fluid, and/or filter cake solids from the wellbore in advance of the cement composition. Embodiments of the spacer fluid may improve the efficiency of the removal of these and other compositions from the wellbore. Removal of these compositions from the wellbore may enhance bonding of the cement composition to surfaces in the wellbore.

The displaced drilling fluid may include, for example, any number of fluids, such as solid suspensions, mixtures, and emulsions. In some embodiments, the drilling fluid may comprise an oil-based drilling fluid. An example of a suitable oil-based drilling fluid comprises an invert emulsion. In some embodiments, the oil-based drilling fluid may comprise an oleaginous fluid. Examples of suitable oleaginous fluids that may be included in the oil-based drilling fluids include, but are not limited to, α-olefins, internal olefins, alkanes, aromatic solvents, cycloalkanes, liquefied petroleum gas, kerosene, diesel oils, crude oils, gas oils, fuel oils, paraffin oils, mineral oils, low-toxicity mineral oils, olefins, esters, amides, synthetic oils (e.g., polyolefins), polydiorganosiloxanes, siloxanes, organosiloxanes, ethers, acetals, dialkylcarbonates, hydrocarbons, and combinations thereof.

The cement composition introduced into the well bore may comprise hydraulic cement and water. In some embodiments, kiln dust may be used in place of some (e.g., up to about 50% by weight or more) or all of the hydraulic cement, for example, up to about. A variety of hydraulic cements may be utilized in accordance with the present invention, including, but not limited to, those comprising calcium, aluminum, silicon, oxygen, iron, and/or sulfur, which set and harden by reaction with water. Suitable hydraulic cements include, but are not limited to, Portland cements, pozzolana cements, gypsum cements, high alumina content cements, slag cements, silica cements, and combinations thereof. In certain embodiments, the hydraulic cement may comprise a Portland cement. In some embodiments, the Portland cements may include cements classified as Classes A, C, H, or G cements according to American Petroleum Institute, API Specification for Materials and Testing for Well Cements, API Specification 10, Fifth Ed., Jul. 1, 1990. In addition, in some embodiments, the hydraulic cement may include cements classified as ASTM Type I, II, or III.

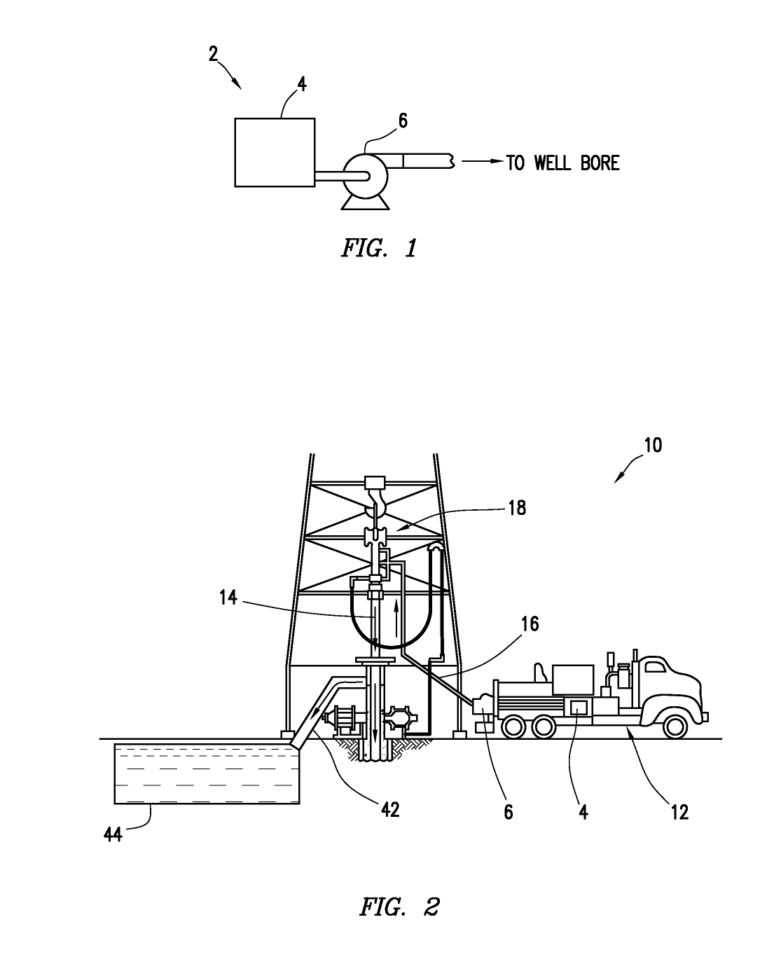

Example methods of using the spacer fluids comprising red mud solids in well cementing will now be described in more detail with reference to FIGS. 1-4. FIG. 1 illustrates an example system 2 for preparation of a spacer fluid comprising red mud solids and water and delivery of the spacer fluid to a wellbore. As shown, the spacer fluid may be mixed in mixing equipment 4, such as a jet mixer, re-circulating mixer, or a batch mixer, for example, and then pumped via pumping equipment 6 to the wellbore. In some embodiments, the mixing equipment 4 and the pumping equipment 6 may be disposed on one or more cement trucks as will be apparent to those of ordinary skill in the art. In some embodiments, a jet mixer may be used, for example, to continuously mix a dry blend comprising the red mud solids and one or more optional additives described herein, for example, with the water as it is being pumped to the wellbore. In some embodiments, red mud comprising red mud solids may be mixed with water and/or additional solids to form the spacer fluid. Any of the previous embodiments of the spacer fluid described previously may apply in the context of FIG. 1.

FIG. 2 illustrates example surface equipment 10 that may be used in placement of a spacer fluid and/or cement composition. It should be noted that while FIG. 2 generally depicts a land-based operation, those skilled in the art will readily recognize that the principles described herein are equally applicable to subsea operations that employ floating or sea-based platforms and rigs, without departing from the scope of the disclosure. As illustrated by FIG. 2, the surface equipment 10 may include a cementing unit 12, which may include one or more cement trucks. The cementing unit 12 may include mixing equipment 4 and pumping equipment 6 as will be apparent to those of ordinary skill in the art. The cementing unit 12 may pump a spacer fluid and/or cement composition in the direction indicated by arrows 14 through a feed pipe 16 and to a cementing head 18 which conveys the fluid downhole. Any of the previous embodiments of a spacer fluid described previously may apply in the context of FIG. 2 with respect to the spacer fluid. For example, the spacer fluid may comprise red mud solids, water, and one or more optional additives.

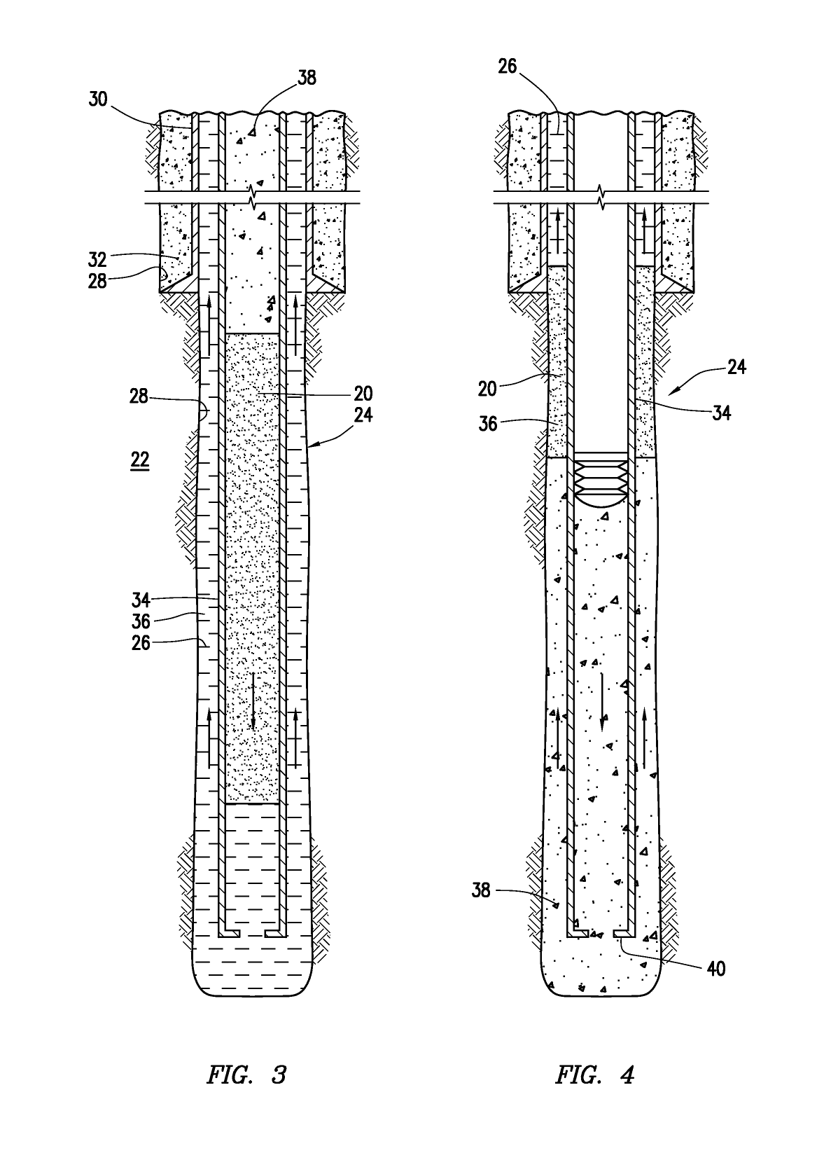

An example of using a spacer fluid 20 comprising red mud solids will now be described with reference to FIG. 3. Any of the previous embodiments of a spacer fluid described previously may apply in the context of FIG. 3 with respect to the spacer fluid 20. For example, the spacer fluid 20 may comprise red mud solids, water, and one or more optional additives.

FIG. 3 depicts one or more subterranean formations 22 penetrated by a wellbore 24 with drilling fluid 26 disposed therein. The drilling fluid 26 may include the example drilling fluids disclosed herein as well as other suitable drilling fluids that will be readily apparent to those of ordinary skill in the art. While the wellbore 24 is shown extending generally vertically into the one or more subterranean formations 22, the principles described herein are also applicable to wellbores that extend at an angle through the one or more subterranean formations 22, such as horizontal and slanted wellbores. As illustrated, the wellbore 24 comprises walls 28. In the illustrated embodiment, a surface casing 30 has been cemented to the walls 28 of the wellbore 24 by cement sheath 32. In the illustrated embodiment, one or more additional pipe strings (e.g., intermediate casing, production casing, liners, etc.), shown here as casing 34 may also be disposed in the wellbore 24. As illustrated, there is a wellbore annulus 36 formed between the casing 34 and the walls 28 of the wellbore 24 (and/or the surface casing 30). While not shown, one or more centralizers may be attached to the casing 30, for example, to centralize the casing 34 in the wellbore 24 prior to and during the cementing operation.

As illustrated, a cement composition 38 may be introduced into the wellbore 24. For example, the cement composition 38 may be pumped down the interior of the casing 34. The pump 6 shown on FIGS. 1 and 2 may be used for delivery of the cement composition 38 into the wellbore 24. It may be desired to circulate the cement composition 38 in the wellbore 24 until it is in the wellbore annulus 36. The cement composition 38 may include the example cement compositions disclosed herein as well as other suitable cement compositions that will be readily apparent to those of ordinary skill in the art. While not illustrated, other techniques may also be utilized for introduction of the cement composition 38. By way of example, reverse circulation techniques may be used that include introducing the cement composition 38 into the wellbore 24 by way of the wellbore annulus 36 instead of through the casing 34.

The spacer fluid 20 may be used to separate the drilling fluid 26 from the cement composition 38. The previous embodiments described with reference to FIG. 1 for preparation of a spacer fluid may be used for delivery of the spacer fluid 20 into the wellbore 24. Moreover, the pump 6 shown on FIGS. 1 and 2 may also be used for delivery of the spacer fluid 20 into the wellbore 24. The spacer fluid 20 may be used with the cement composition 38 for displacement of the drilling fluid 26 from the wellbore 24 as well as preparing the wellbore 24 for the cement composition 38. By way of example, the spacer fluid 20 may function, inter alia, to remove the drilling fluid 26, drilling fluid 26 that is dehydrated/gelled, and/or filter cake solids from the wellbore 24 in advance of the cement composition 38. While not shown, one or more plugs or other suitable devices may be used to physically separate the drilling fluid 26 from the spacer fluid 20 and/or the spacer fluid 20 from the cement composition 38.

Referring now to FIG. 4, the drilling fluid 26 has been displaced from the wellbore annulus 36 in accordance with certain embodiments. As illustrated, the spacer fluid 20 and the cement composition 38 may be allowed to flow down the interior of the casing 34 through the bottom of the casing 34 (e.g., casing shoe 40) and up around the casing 34 into the wellbore annulus 36, thus displacing the drilling fluid 26. At least a portion of the displaced drilling fluid 26 may exit the wellbore annulus 36 via a flow line 42 and be deposited, for example, in one or more retention pits 44 (e.g., a mud pit), as shown in FIG. 2. Turning back to FIG. 4, the cement composition 38 may continue to be circulated until it has reached a desired location in the wellbore annulus 36. The spacer fluid 20 and/or the cement composition 38 may be left in the wellbore annulus 36. As illustrated, the spacer fluid 20 may be disposed in the wellbore annulus 36 above or on top of the cement composition 38. The cement composition 38 may set in the wellbore annulus 36 to form an annular sheath of hardened, substantially impermeable material (i.e., a cement sheath) that may support and position the casing 34 in the wellbore 24. As previously mentioned, embodiments of the spacer fluid 20 may consolidate in the wellbore annulus 36. Thus, the spacer fluid 20 may help to stabilize the casing 34 while also serving to provide a barrier to protect the portion of the casing 34 from corrosive effects of water and/or water-based drilling fluids that would otherwise remain in the wellbore annulus 36 above the cement composition 38.

The exemplary red mud solids disclosed herein may directly or indirectly affect one or more components or pieces of equipment associated with the preparation, delivery, recapture, recycling, reuse, and/or disposal of the red mud solids and associated spacer fluids. For example, the red mud solids may directly or indirectly affect one or more mixers, related mixing equipment 4, mud pits, storage facilities or units, composition separators, heat exchangers, sensors, gauges, pumps, compressors, and the like used generate, store, monitor, regulate, and/or recondition the exemplary red mud solids and fluids containing the same. The disclosed red mud solids may also directly or indirectly affect any transport or delivery equipment used to convey the red mud solids to a well site or downhole such as, for example, any transport vessels, conduits, pipelines, trucks, tubulars, and/or pipes used to compositionally move the red mud solids from one location to another, any pumps, compressors, or motors (e.g., topside or downhole) used to drive the red mud solids, or fluids containing the same, into motion, any valves or related joints used to regulate the pressure or flow rate of the red mud solids (or fluids containing the same), and any sensors (i.e., pressure and temperature), gauges, and/or combinations thereof, and the like. The disclosed red mud solids may also directly or indirectly affect the various downhole equipment and tools that may come into contact with the red mud solids such as, but not limited to, wellbore casing 34, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

### EXAMPLES

To facilitate a better understanding of the present invention, the following examples of some of the preferred embodiments are given. In no way should such examples be read to limit, or to define, the scope of the invention.

### Example 1

A sample of red mud was obtained from an alumina manufacturer and subjected to oxide analysis by EDXRF (Energy Dispersive X-Ray Fluorescence) which showed the following composition by weight:

TABLE 1
Full Oxide Analysis of Red Mud

| | Full Oxide (wt %) | Loss Corrected (wt %) |
|---|---|---|
| Na₂O | 1.19 | 1.34 |
| MgO | 0.07 | 0.08 |
| Al₂O₃ | 17.3 | 19.47 |
| SiO₂ | 29.77 | 33.51 |
| SO₃ | 0.98 | 1.1 |
| K₂O | 1.18 | 1.33 |
| CaO | 18.27 | 20.57 |
| P₂O₅ | 1.29 | 1.45 |
| TiO₂ | 3.09 | 3.48 |
| Mn₂O₃ | 0.33 | 0.37 |
| Fe₂O₃ | 15.31 | 17.23 |
| ZnO | 0.02 | 0.02 |
| SrO | 0.04 | 0.05 |
| LOI | 11.16 | — |
| Moisture Content | 22.94 | |

The sample of red mud was subjected to X-ray diffraction analysis with Rietveld Full Pattern refinement, which showed the following crystalline materials present by weight:

TABLE 2
XRD of Red Mud

| Name | Formula | Red Mud (wt %) |
|---|---|---|
| Calcite | CaCO₃ | 22 |
| Quartz | SiO₂ | 30 |
| Hatrutite | (C₃S) | 2 |
| Larnite | (C₂S) | 2 |
| Brownmillerite | (C₄AF) | Trace |
| Hematite | Fe₂O₃ | 10 |
| Magnetite | Fe₃O₄ | 1 |
| Hauyne | Na₃CaAl₃Si₃O₁₂(SO₄)₂ | 9 |
| Anhydrite | CaSO₄ | 1 |
| Gibbsite | Al(OH)₃ | 4 |
| K-feldspar | KAlSi₃O₈ | 4 |
| Kaolinite | — | 10 |
| Muscovite | — | 5 |

The sample of the red mud was also subjected to particle size analysis using a Malvern Mastersizer® 3000 laser diffraction particle size analyzer, which showed the following particle size for the solids in the red mud:

TABLE 3
Particle Size Analysis

| Particle Size | |
|---|---|
| Distribution | Red Mud Solids |
| D10 (microns) | 2.48 |
| D50 (microns) | 31.2 |
| D90 (microns) | 333 |

The density of the sample of the red mud was also determined using a Quantachrome® Ultrapyc 1200. The density was determined before and after drying. The sample was dried in a vacuum oven at 180° F. for 24 hours. The density in grams per cubic centimeter is provided in the table below.

TABLE 4
Density Analysis

| Red Mud | Density (g/cc) |
|---|---|
| As received | 2.04 |
| Dried | 2.86 |

### Example 2

Sample spacer fluids were prepared to evaluate the rheological properties of spacer fluids containing red mud solids. To prepare the sample spacer fluids comprising red mud solids, the as-received red mud from Example 1 was used. Two sample spacer fluids, labeled Samples 1 and 2 in the table below, were prepared by mixing the red mud with tap water in a Waring blender jar with 4,000 rpm stirring. In Sample 2, lime was blended with the red mud prior to combination with the water. The blender speed was then increased to 12,000 rpm for about 35 seconds.

Sample No. 1 had a density of 12 ppg and was prepared by mixing 215.36 grams of red mud and 144.15 grams of water. Based on a moisture content for the red mud of 22.94%, Sample 1 contained approximately 165.96 grams of red mud solids and 193.55 grams of water.

Sample No. 2 had a density of 12 ppg and was prepared by mixing 193.62 grams of red mud, 19.36 grams of hydrated lime and 146.52 grams of water. Based on a moisture content for the red mud of 22.94%, Sample 2 contained approximately 149.2 grams of red mud solids, 19.36 grams of hydrated lime, and 190.94 grams of water.

Rheological values were then determined using a Fann Model 35 Viscometer. Dial readings were recorded at speeds of 3, 6, 100, 200, and 300 with a B1 bob, an RI rotor, and a 1.0 spring. The dial readings for the spacer fluids were measured in accordance with API Recommended Practices 10B, Bingham plastic model and are set forth in the table below. The results provided in the table below are an average of two tests. The abbreviation “% bwom” in the table refers to percent by weight of the red mud.

TABLE 5
Rheological Analysis

| | Red Mud | Hydrated Lime | Temp. | Viscometer RPM | | | | | | |
|---|---|---|---|---|---|---|---|---|---|---|
| Sample | (% bwom) | (% bwom) | (° F.) | 300 | 200 | 100 | 6 | 3 | 3D | 6D |
| 1 | 100 | 0 | 80 | 30 | 23 | 23 | 23 | 23 | 20 | 15 |
| | | | 180 | 31 | 28 | 28 | 28 | 28 | 26 | 22 |
| 2 | 100 | 10 | 80 | 64 | 56 | 56 | 52 | 48 | 48 | 49 |
| | | | 180 | 52 | 44 | 42 | 42 | 38 | 32 | 38 |

### Example 3

The following series of tests were performed to determine the compressive strength of spacer fluids comprising red mud. Two samples, labeled samples 3 and 4 in the table below, were preparing having a density of 13.6 ppg. The samples were prepared by mixing the red mud with tap water in a Waring blender jar with 4,000 rpm stirring. In Sample 3, lime was blended with the red mud prior to combination with the water. In Sample 4, pumice was blended with the red mud prior to combination with the water. The blender speed was then increased to 12,000 rpm for about 35 seconds. The red mud was the as-received red mud from Example 1.

Sample No. 3 had a density of 13.6 ppg and was prepared by mixing 300 grams of red mud, 60 grams of hydrated lime, 1.14 grams of a dispersant, and 123.9 grams of water. Based on a moisture content for the red mud of 22.94%, Sample No. 3 comprised 231.18 grams of red mud solids, 60 grams of hydrated lime, 1.14 grams of dispersant, and 192.72 grams of water. The dispersant used was Liquiment® 514L dispersant, available from BASF Corporation, Houston, Tex.

Sample No. 4 had a density of 13.6 ppg and comprised 300 grams of red mud, 30 grams of pumice, and 167.1 grams of water. Based on a moisture content for the red mud of 22.94%, Sample No. 4 comprised 231.18 grams of red mud solids, 30 grams of pumice, and 235.92 grams of water. The pumice used was supplied by Hess Pumice Products.

After preparation, the samples were poured into 1-inch by 2-inch brass cylinders and cured in a water bath at 180° F. for 24 hours. Immediately after removal from the water bath, destructive compressive strengths were determined using a Tinius Olsen mechanical press in accordance with API RP 10B-2. Two sets of each sample were prepared. One set was cured with no cement set activator (Neat), and the other set was cured with 10% bwom calcium chloride. The calcium chloride was added to the samples as a 43 weight % calcium chloride solution.

The results of this test are set forth below. The results are an average of three tests for each sample. The abbreviation “% bwom” in the table refers to percent by weight of the red mud.

TABLE 6
Compressive Strength Measurements

| | Sample 3 | Sample 4 |
|---|---|---|
| Component | | |
| Water (% bwom) | 41.3 | 55.7 |
| Pumice (% bwom) | 0.0 | 10 |
| Red Mud (% bwom) | 100 | 100 |
| Hydrate Lime (% bwom) | 20 | 0.0 |
| Dispersant (% bwom) | 0.38 | 0.0 |
| Compressive Strength at | | |
| 180° F. (psi) | | |
| Neat | Consolidated, <50 psi | Soft gel |
| 10% CaCl₂ | 234 | Consolidated, <50 psi |

As can be seen in Table 6, Sample 3 with no cement set activator consolidated into a semi-hardened mass with a compressive strength that was estimated to be below 50 psi. Sample 3 with the cement set activator developed compressive strength and had a compressive strength of 234 psi after 24 hours at 180° F. Sample 4 with no cement set activator did not develop compressive strength, but was observed to be no longer in slurry form and had the consistency of a soft gel. Sample 4 with the cement set activator consolidated into a semi-hardened mass with a compressive strength that was estimated to be below 50 psi.

The preceding description provides various embodiments of the spacer fluids containing different additives and concentrations thereof, as well as methods of using the spacer fluids. It should be understood that, although individual embodiments may be discussed herein, the present disclosure covers all combinations of the disclosed embodiments, including, without limitation, the different additive combinations, additive concentrations, and fluid properties.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method comprising:
using a spacer fluid comprising red mud solids and water to displace a drilling fluid in a wellbore.

2. The method of claim 1 wherein the drilling fluid comprises an oil-based drilling fluid.

3. The method of claim 1 wherein the red mud solids are an insoluble residue from extraction of alumina from bauxite ore.

4. The method of claim 1 wherein the red mud solids are present in an amount of about 0.1% to about 80% by weight of the spacer fluid.

5. The method of claim 1 wherein the red mud solids are present in an amount of about 40% to about 70% by weight of the spacer fluid.

6. The method of claim 1 wherein the spacer fluid further comprises hydrated lime.

7. The method of claim 1 wherein the spacer fluid further comprises a cement set activator.

8. The method of claim 7 wherein the cement set activator comprises calcium chloride.

9. The method of claim 1 wherein the spacer fluid further comprises at least one additive selected from the group consisting of cement kiln dust, lime kiln dust, pumice, and any combination thereof.

10. The method of claim 1 wherein the spacer fluid comprises at least one additive selected from the group consisting of a free water control additive, a lightweight additive, a foaming agent, a supplementary cementitious material, a weighting agent of any suitable size, a viscosifying agent, a fluid loss control agent, a lost circulation material, a filtration control additive, a dispersant, a defoamer, a corrosion inhibitor, a scale inhibitor, a formation conditioning agent, a water-wetting surfactant, and any combination thereof.

11. The method of claim 1 wherein the spacer fluid comprises at least one additive selected from the group consisting of gypsum, fly ash, bentonite, hydroxyethyl cellulose, sodium silicate, a hollow microsphere, gilsonite, perlite, a gas, an organic polymer, a biopolymer, latex, ground rubber, a surfactant, crystalline silica, amorphous silica, silica flour, fumed silica, nano-clay, salt, fiber, hydratable clay, rice husk ash, micro-fine cement, metakaolin, zeolite, shale, pumicite, Portland cement, Portland cement interground with pumice, barite, slag, lime, and any combination thereof.

12. The method of claim 1 further comprising pumping the spacer fluid down an interior of a pipe string, out through a bottom of the pipe string, and into a wellbore annulus.

13. The method of claim 1 further comprising introducing a cement composition into the wellbore after the spacer fluid, wherein the spacer fluid separates the cement composition from the drilling fluid.

14. The method of claim 1 further comprising allowing at least a portion of the spacer fluid to remain in the wellbore.

15. The method of claim 14 wherein the portion of the spacer fluid that remains in the wellbore has a compressive strength of at least about 50 pounds per square inch.

16. A method comprising:
using a spacer fluid comprising red mud solids, hydrated lime, and water to displace an aqueous drilling fluid in a wellbore annulus; and
introducing a cement composition into the wellbore annulus after the spacer fluid,
wherein at least a portion of the spacer fluid consolidates in the wellbore annulus to form a hardened mass.

17. The method of claim 16 wherein the red muds are an insoluble residue from extraction of alumina from bauxite ore.

18. The method of claim 16 wherein the spacer fluid further comprises a cement set activator.

19. The method of claim 16 wherein the cement set activator comprises calcium chloride.

20. A system comprising:
a cement composition for use in cementing in a wellbore;
a spacer fluid for separating the cement composition from a drilling fluid in the wellbore, wherein the spacer fluid comprising red mud solids and water;
mixing equipment for mixing the spacer fluid; and
pumping equipment for delivering the spacer fluid into a wellbore.

21. The system of claim 20 wherein the red mud solids are an insoluble residue from extraction of alumina from bauxite ore.

22. The system of claim 20 wherein the spacer fluid further comprises a cement set activator.
